(19) United States
(12) Patent Application Publication
(10) Pub. No.: US 2014/0122417 A1
(43) Pub. Date: May 1, 2014

(54) TRANSACTION PROCESSING METHOD, PROGRAM, AND SYSTEM

(71) Applicant: International Business Machines Corporation, Armonk, NY (US)

(72) Inventors: Hiroshi Horii, Tokyo (JP); Hiroshi Inoue, Tokyo (JP)

(73) Assignee: International Business Machines Corporation, Armonk, NY (US)

(21) Appl. No.: 14/060,659

(22) Filed: Oct. 23, 2013

(30) Foreign Application Priority Data
Oct. 25, 2012 (JP) 2012-235224

(51) Int. Cl. G06F 17/30

(52) U.S. Cl. CPC G06F 17/30377
USPC 707/607

(57) ABSTRACT

A method, system, and computer program product to solve the problem of consistency in processing when one server performs a transmission transaction and a reception transaction in an in-line processing manner. In a system according to this invention, a local buffer is generated at the time of starting a transmission transaction, and a message is inserted in the local buffer at the time of transmission processing. At the time of commitment of the transmission transaction, after reception transaction processing on all messages in the local buffer, processing for commitment to the data base is performed. Processing for the reception transaction is performed as a nested transaction in the transmission transaction.

### CROSS-REFERENCE TO RELATED APPLICATION

This application claims priority under 35 U.S.C. §119 from Japanese Patent Application No. 2012-235224 filed Oct. 25, 2012, the entire contents of which are incorporated herein by reference.

### BACKGROUND OF THE INVENTION

1. Field of the Invention

This invention relates to a technique for message processing in a distributed processing system.

2. Description of the Related Art

A method to perform distributed transactions of data accesses on a database system and transmitting or receiving messages in a distributed processing system constructed in accordance with Java®2 Enterprise Edition (J2EE), for example, and having data in a plurality of servers.

Ordinary message processing on J2EE resides in performing transactions by sending, with a mechanism such as Java® Message Service (JMS), by means of a messaging queue 110, a message from a server 102 on a transmitting side (sender), which is one of two different servers in a distributed processing system, to a server 106 on a receiving side (receiver), which is the other of the two different servers, as shown in FIG. 1.

More specifically, server 102 on the transmitting stores a message in messaging queue 110 as a transmission transaction (SendTx) 108.

On the other hand, server 106 on the receiving side takes out the message from messaging queue 110 as a reception transaction (RecvTx) 114.

This message transmission/reception is processed in the transaction scope under execution. When server 102 on the transmitting side accesses data in database 104 before sending a message, the SendTx includes not only storing of a message in the queue, but also accessing data in the database. When server 106 on the receiving side accesses data in database 104 after receiving a message, the RecvTx includes not only taking out the message, but also accessing data in the database. If database access has been rolled backed in failure, the co-executing transmission/reception is also rolled back.

The order of messages is not considered in the system. In other words, if one message has been sent following the other messages, the message can be taken out in a RecvTx before the other messages.

In designing a scalable architecture with multiple servers for an application using messaging processing, it is desirable, to provide one server 202 both as a receiving-side server and as a transmitting-side server, as shown in FIG. 2, to make loads of each server uniform. It can easily be determined that, in Enterprise Java® Beans (EJB)3.0, there is a possibility of transmission processing and reception processing being performed in one server. In EJB 3.0, application annotates variables of a message queue for transmitting a message, and annotates a callback method for receiving the message from the message queue. Middleware, such as WebSphere, recognizes points of sending and receiving in application with reading the annotations and also, recognizes a possibility of transmission processing and reception processing.

If a message is transmitted and received in a server 202, server 202 accesses a database 204, receives a reply, thereafter stores a message in a messaging queue 206, and executes a transmission transaction 210 before commitment to database 204.

Thereafter, server 202 takes out the message from messaging queue 206, accesses database 208, and executes reception transaction 212 before sending a message to messaging queue 206.

A further advancement of the optimization is that the processing of RecvTx 312 is included into the processing of SendTx 310 when one server 302 is used for transmitting and receiving, as shown in FIG. 3. After application sends a message (SendTx), the message is immediately processed (RecvTx), and then, the application continues the processing (SendTx). In this case, messaging queue 306 is not used for exchange of messages between transmission and reception. This arrangement enables reducing the message overhead by synchronously processing the reception transaction.

However, with processing of a reception transaction in-line with a transmission transaction, there is a problem that consistency of processing cannot be ensured, for example, with respect to querying by the transmission transaction a record updated by the reception transaction, updating by the transmission transaction a record queried by the reception transaction, and roll back of the reception transaction.

A technique relating to a nest of transactions formed by nesting a transaction in another transaction is known.

Japanese Patent Application No. JP2001-188696A discloses making each of a process capable of executing a nest of transactions and a process incapable of executing the nest of transactions execute a subtransaction in the nest of transactions, performing commitment processing with respect to the subtransaction executed by the process capable of executing the nest of transactions, executing the top-level transaction in the nest of transactions, performing commitment processing with respect to the executed top-level transaction, and completing commitment processing with respect to the subtransaction executed by the process incapable of executing the nest of transactions simultaneously with the completion of the commitment processing with respect to the top-level transaction. The transaction nest execution technique disclosed in the patent literature cannot be applied to solve the consistency problem of processing in the case of performing as in-line processing the reception processing shown in FIG. 3.

It is, therefore, an object of this invention to solve the problem of consistency in transaction processing and messaging processing when one server performs a transmission transaction and a reception transaction as one transaction.

### SUMMARY OF INVENTION

According to the broadest aspect of the present invention, a computer implemented method for processing transmission and reception transaction is provided. The method includes the steps of: generating a local buffer at the time of starting the transmission transaction; inserting a message in the local buffer at the time of transmission processing; processing reception transaction on all messages in the local buffer; and processing the transmission and reception transactions for commitment to a database; wherein the processing steps are performed sequentially or simultaneously.

According to one aspect of the present invention, the above-described problem is solved by a method for processing in a system in which message transmission processing between applications and data processing on a database system are performed as one transmission transaction by means of processing with a computer, and in which message reception processing between the applications and data processing on the database system are performed as one reception transaction by means of processing with the computer, the method including processing the two transactions as one transaction in a case where the message transmission processing and the message reception processing between the applications are performed in one server system. The method includes: generating a local buffer at the time of starting the transmission transaction; inserting a message in the local buffer at the time of transmission processing; processing reception transaction on all messages in the local buffer; and processing for commitment to a database; where the processing steps are performed sequentially or simultaneously.

According to a second aspect of the present invention, a computer program product is provided for processing in a system in which message transmission processing between applications and data processing on a database system are performed as one transmission transaction by means of processing with a computer, and in which message reception processing between the applications and data processing on the database system are performed as one reception transaction by means of processing with the computer, processing performed by the program product including processing the two transactions as one transaction in a case where the message transmission processing and the message reception processing between the applications are performed in one server system, the program product including a computer readable storage medium having program code embodied therewith, the program code readable/executable by a device causing the server system to execute the steps of a method. The method includes: generating a local buffer at the time of starting the transmission transaction; inserting a message in the local buffer at the time of transmission processing; processing reception transaction on all messages in the local buffer; and processing for commitment to a database; wherein the processing steps are performed sequentially or simultaneously.

According to a third aspect of the present invention, a system is provided in which message transmission processing between applications and data processing on a database system are performed as one transmission transaction by means of processing with a computer, in which message reception processing between the applications and data processing on the database system are performed as one reception transaction by means of processing with the computer, and in which the two transactions are processed as one transaction in a case where the message transmission processing and the message reception processing between the applications are performed as one server system. The system includes: a memory; a processor communicatively coupled to the memory; and a module communicatively coupled to the memory and the processor, where the module is configured to perform the steps of a method. The method includes: generating a local buffer at the time of starting the transmission transaction; inserting a message in the local buffer at the time of transmission processing; processing reception transaction on all messages in the local buffer; and processing for commitment to a database; wherein the processing steps are performed sequentially or simultaneously.

### BRIEF DESCRIPTION OF DRAWINGS

FIG. 1 is a diagram showing an example of a case where a transmission transaction and a reception transaction are performed by separate servers in the conventional art.

FIG. 2 is a diagram showing an example of a case where a transmission transaction and a reception transaction are performed by one server in the conventional art.

FIG. 3 is a diagram showing a reception processing is performed as in-line processing by the same server.

FIG. 4 is a diagram schematically showing an example of a hardware configuration according to an embodiment of the present invention.

FIG. 5 is a diagram showing a hardware configuration of a server according to an embodiment of the present invention.

FIG. 6 is a diagram showing nested transaction processing according to an embodiment of the present invention.

FIG. 7 is a diagram showing a flowchart of start processing in a transmission transaction in middleware according to an embodiment of the present invention.

FIG. 8 is a diagram showing a flowchart of query/update processing in the transmission transaction in middleware according to an embodiment of the present invention.

FIG. 9 is a diagram showing a flowchart of message processing in the transmission transaction in the middleware according to an embodiment of the present invention.

FIG. 10 is a diagram showing a flowchart of commitment processing in the transmission transaction in the middleware according to an embodiment of the present invention.

FIG. 11 is a diagram showing a flowchart of start processing in a reception transaction in the middleware according to an embodiment of the present invention.

FIG. 12 is a diagram showing a flowchart of query processing in the reception transaction in the middleware according to an embodiment of the present invention.

FIG. 13 is a diagram showing a flowchart of update processing in the reception transaction in the middleware according to an embodiment of the present invention.

FIG. 14 is a diagram showing a flowchart of roll back processing in the reception transaction in the middleware according to an embodiment of the present invention.

FIG. 15 is a diagram showing a flowchart of commitment processing in the reception transaction in the middleware according to an embodiment of the present invention.

### DETAILED DESCRIPTION OF THE PREFERRED EMBODIMENTS

An embodiment of the present invention will be described below with reference to the drawings. The same reference numerals indicate objects identical to each other throughout the drawings unless otherwise specified. The following description describes only an embodiment of the present invention and is not to be construed to limit the present invention to details described with respect to the embodiment.

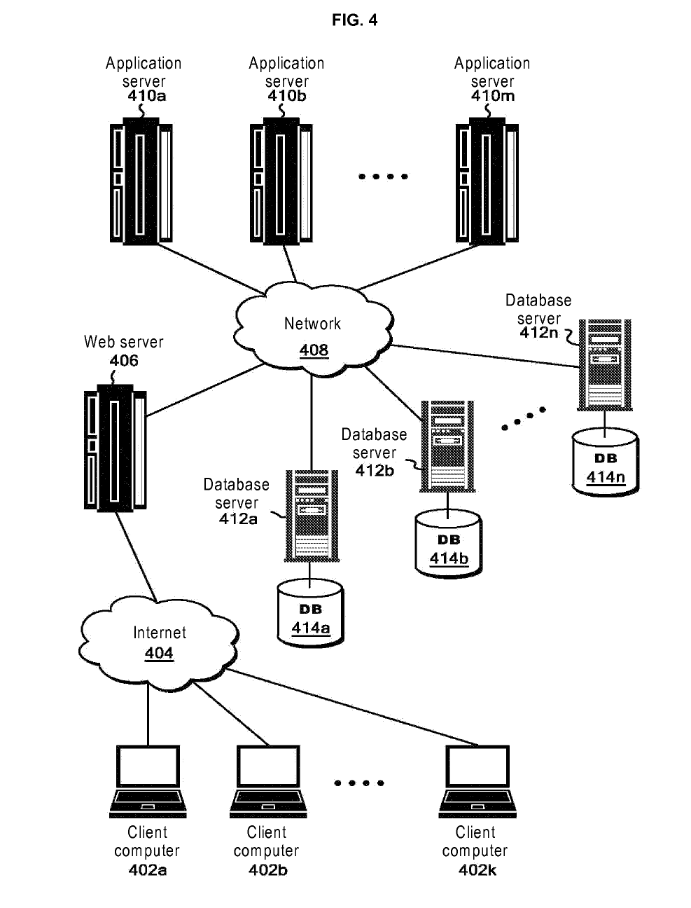

FIG. 4 is a diagram schematically showing an example of a hardware configuration for carrying out an embodiment of the present invention. Referring to FIG. 4, client computers 402a, 402b, . . . , 402k are connected to a Web server 406 through Internet 404.

Web server 406 is connected to application servers 410a, 410b, . . . , 410m and to database servers 412a, 412b, . . . , 412n through a network 408. Network 408 can be used as a network in any form, such as a LAN, WAN, or FTTP, connecting a plurality of servers. Databases 414a, 414b, . . . , 414n are respectively associated with database servers 412a, 412b, . . . , 412n. Databases 414a, 414b, . . . , 414n can be stored, respectively, in local disks in database servers 412a, 412b, . . . , 412n, or can be each constituted by an storage area network (SAN) and a network attached storage (NAS) and connected to the corresponding one of database servers 412a, 412b, . . . , 412n through network 408.

In the illustrated configuration in FIG. 4, the application servers and the database servers are hardware machines separate from each other. However, the configuration can alternatively be such that the database servers are also configured in the machines in which the application servers are configured, so that each one machine functions as an application server and as a database server.

Each request, for example, for querying, updating, and deleting on the databases sent from client computers 402a, 402b, . . . , 402k to Web server 406 is routed to the predetermined, any one of database servers 412a, 412b, . . . , 412n through one of application servers 410a, 410b, . . . , 410m to be processed.

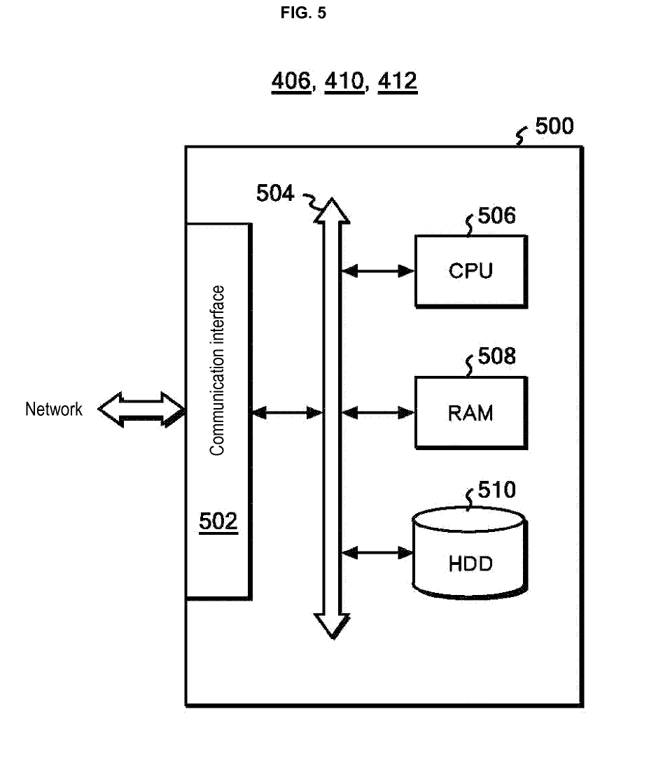

FIG. 5 shows a configuration common to Web server 406, application servers 410, and database servers 412. The common server is referred to simply as “server 500” below.

A communication interface 502 of server 500 is connected to network 408. Communication interface 502 is also connected to a bus 504. A CPU 506, a main storage (RAM) 508, and a hard disk drive (HDD) 510 are connected to bus 504.

A keyboard, a mouse, and a display, not illustrated, are also connected to server 500. A maintenance person can perform management and maintenance operations on server 106 with these devices.

An operating system is stored in hard disk drive 510 of server 500. Java® EE for realizing a Java® virtual environment is also introduced into hard disk drive 510.

In a case where server 500 is Web server 406 or each application server 410, an IBM® WebSphere™ application server (WAS) is preferably introduced into hard disk drive 510. The WAS in server 500 operates as a piece of middleware having, for example, a Web container function, an EJB container function, and a transaction management function. In the case where server 500 is Web server 406, the Web server functions are provided by the IBM® HTTP server included in the WAS.

A WAS deployment manager is introduced into and set up in each individual application server 410 for the purpose of performing integrated management of the plurality of application servers 410.

A Java Database Connectivity (JDBC) driver is also introduced into each application servers 410 for access to the database servers to prepare a data source and make a database connection configuration.

Further, a Java® Message Service (JMS) class library is introduced into and configured in each application server 410 for the purpose of realizing asynchronous processing in accordance with J2EE. In addition, a message oriented middleware (MOM) domain is introduced and an application forms an asynchronous messaging system for the database by using the JMS and by cooperating with the MOM.

In each database server 412, a database management application such as DB2 is introduced.

As the above-described server 500, a server selected from models including IBM® System X, System i, and System x, purchasable from the International Business Machines Corporation can be used, but server 500 is not limited to this. Examples of an operating system usable in such a case are AIX, (a trademark of) UNIX®, Linux™, and Windows® 2003 Server.

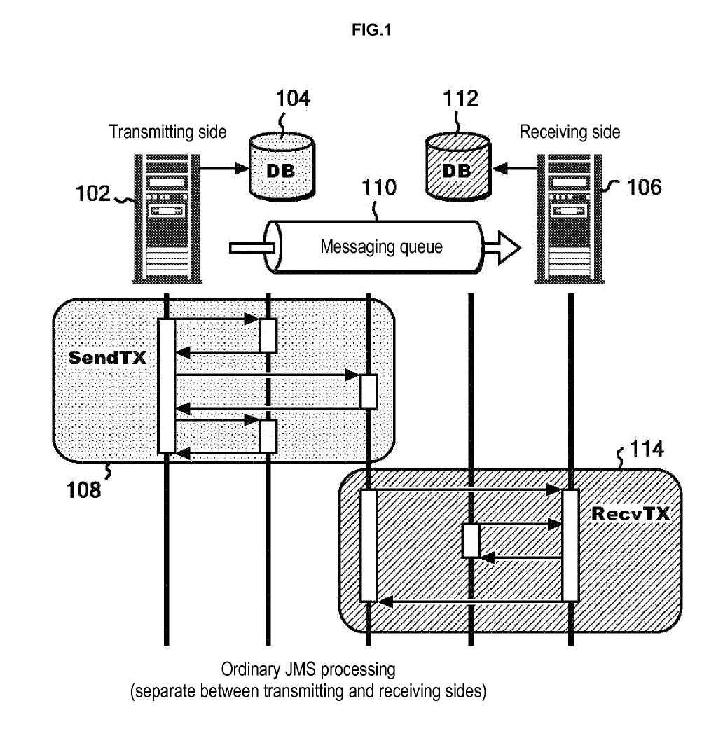

The background art will be described again by referring to FIG. 1 before describing features of the present invention. The following is an example of a code for transmission transaction 108 in FIG. 1.

```
@Resource(mappedName=“jms/FulfillOrderQueueConnectionFactory”)
protected QueueConnectionFactory fulfillOrderQueueConnFactory;
@Resource(mappedName=“jms/FulfillOrderQueue”)
protected Queue fulfillQueue;
public void sendOrderFulfilledMessage(WorkOrder workOrder) {
  QueueConnection con =
    fulfillOrderQueueConnFactory.createQueueConnection( );
  QueueSession session =
    con.createQueueSession(true, Session.AUTO_ACKNOWLEDGE);
  QueueSender sender = session.createSender(fulfillQueue);
  TextMessage message = session.createTextMessage( );
  ......
  sender.send(message);
```

In this code jms/FullOrderQueue is a queue to be transmitted, and sender.send(message) is transactional transmission processing.

The following is an example of a code for reception transaction 114.

```
@MessageDriven(mappedName=“jms/FulfillOrderQueue”,
        activationConfig = {@ActivationConfigProperty(
          propertyName=“destinationType”,
          propertyValue=“javax.jms.Queue”)})
public class FulfillOrderMDB implements MessageListener {
  @Resource
  private MessageDrivenContext messageDrivenContext;
  public void onMessage(Message message) {
          ......
  }}
```

In this code, a queue received at @MessageDriven(mappedName=“jms/FulfillOrderQueue” corresponds to a class. Also, on Message is executed as a transaction.

In this case, server 102 on the transmitting side, in FIG. 1, is one of application servers 410a, 410b, . . . 410m, and server 106 on the receiving side is another one of application servers 410a, 410b, . . . , 410m. Also, database 104 is one of database servers 412a, 412b, . . . , 412n (and databases 414a, 414b, . . . , 414n respectively associated with database servers 412a, 412b, . . . , 412n), and database 112 is another one of database servers 412a, 412b, . . . , 412n (and databases 414a, 414b, . . . , 414n respectively associated with database servers 412a, 412b, . . . , 412n).

In this processing, a message is produced by calling up JMS API, and message transmission/reception is processed in the transaction scope under execution. At this time, transmission/reception ends in failure with roll back. The order of messages is not considered, as long as no particular designation is made.

While in the processing shown in FIG. 1, server 102 on the transmitting side and server 106 on the receiving side are separate from each other; data updated and queried in a transmission transaction is ordinarily referred to in a reception transaction in actual processing.

For example, in message processing for notifying an order history,
Transmitting side: An article of commerce (item) is queried at the time of ordering.
Receiving side: The article of commerce is queried in order to record the history.

In some cases, corresponding data items can be cached in one application server. In the case of the example shown above, non-changeable (immutable) attributes of an article of commerce are cacheable. In the case of SPECjEnterprise2010 (http://www.spec.org/jEnterprise2010/), all attributes of an item are non-changeable (immutable) and cacheable.

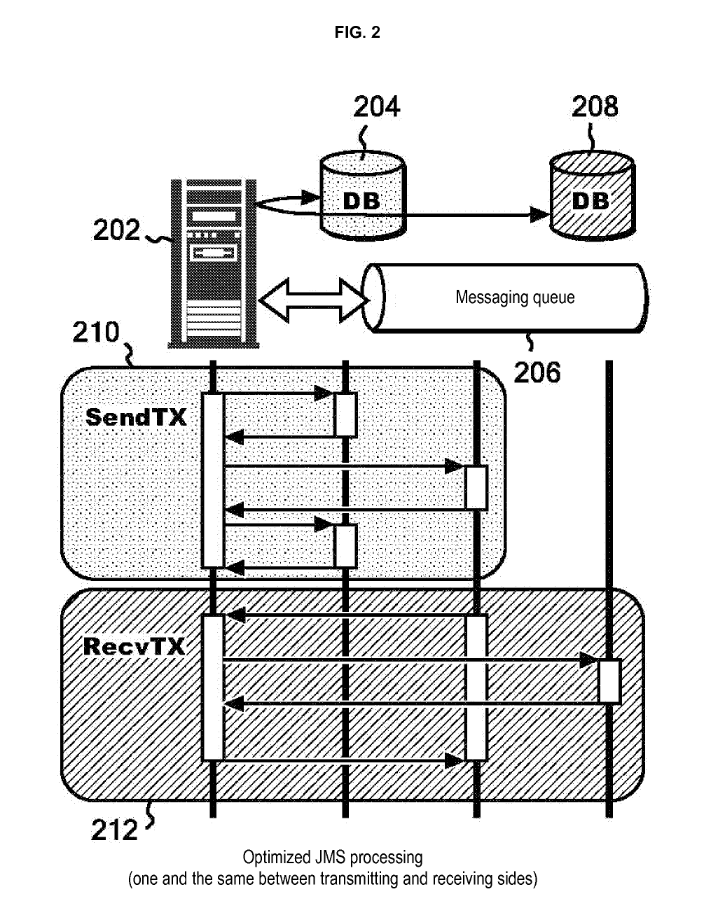

FIG. 2 shows JMS processing optimized in this way to be processed by one server 202.

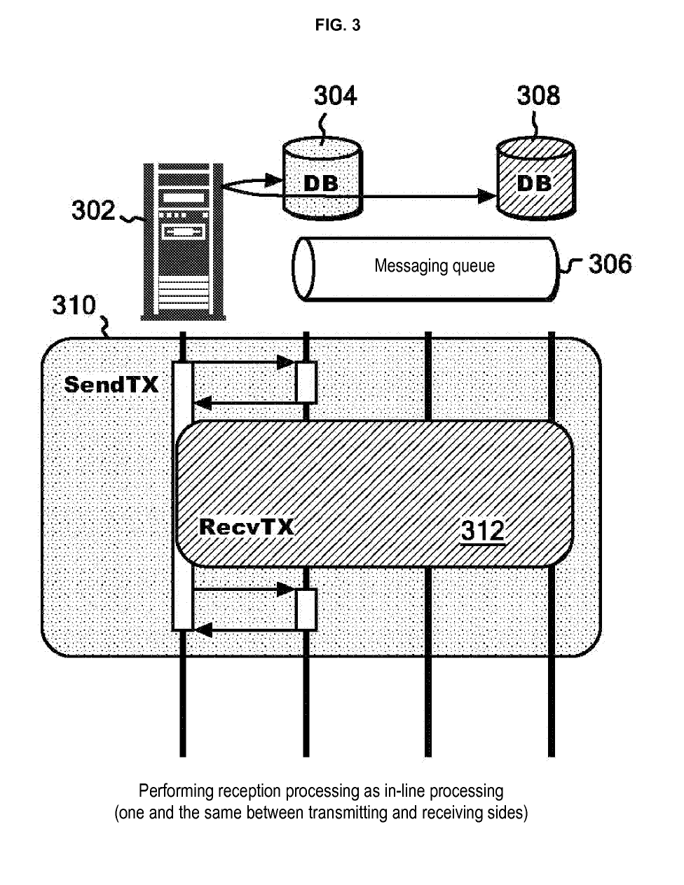

For further optimization of the processing shown in FIG. 2, reception processing is performed as in-line processing as shown in FIG. 3. With this processing, the problem is that consistency in processing cannot be ensured, as described above. According to an embodiment of the present invention, the problem of consistency in processing is solved by customizing transaction processing functions of middleware in an application server 602, which is one of application servers 410a, 410b, . . . , 410m shown in FIG. 4, so as to realize functions shown in FIG. 6, by temporarily generating a local buffer 604 in application server 602, and by inserting a message in local buffer 604 at the time of transmission.

That is, the middleware in application server 602 first generates local buffer 604 at the starting time of a transmission transaction (SendTx) 606, and inserts a message in local buffer 604 at the time of transmission processing.

Next, at the time of commitment of transmission transaction 606, after processing in a reception transaction (RecvTx) 608 on all messages in local buffer 604, the middleware performs processing for commitment to database 610 or 612.

Reception transaction 608 is processed as a nested transaction in transmission transaction 606. That is,
Start processing: no processing is performed.
Query processing: ordinary database query (an update of transmission transaction 606 can also be queried)
Update processing: a value before update is stored and database 610 or 612 is updated.
Commitment processing: the stored value before update is deleted.
Roll back processing: The stored value before update is restored and the message is inserted in a message queue 614.

That is, message reception processing is performed at the time of commitment of the nested transaction. The following processing can thereby be omitted to improve the performance.
Message data transmission processing for insertion, query and deletion processing on the database
Reception transaction commitment processing (processable for commitment together with the transmission transaction)
   Communication processing in the application server relating to this and processing for commitment to the database (caused by batching multiple transactions as a transaction) are also reduced.

According to this invention, a local buffer is generated at the time of starting a transmission transaction, and a message is inserted in the local buffer at the time of transmission processing, thereby obtaining the effect of solving the problem of consistency in processing when one server processes a reception transaction in-line with a transmission transaction.

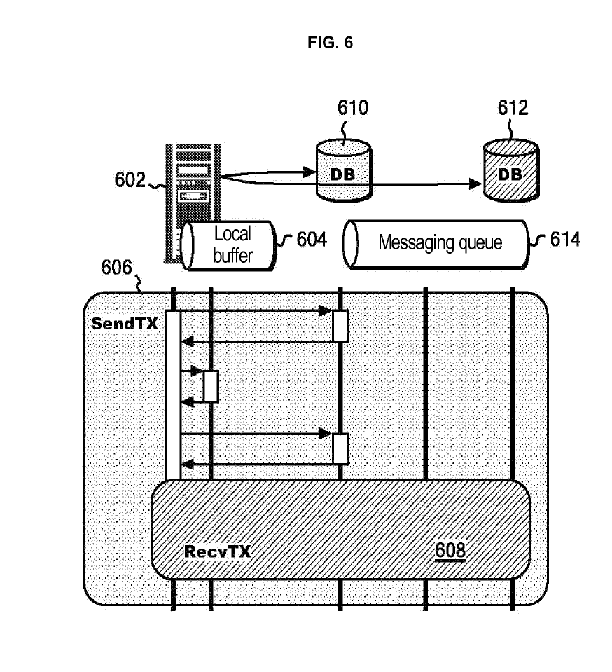

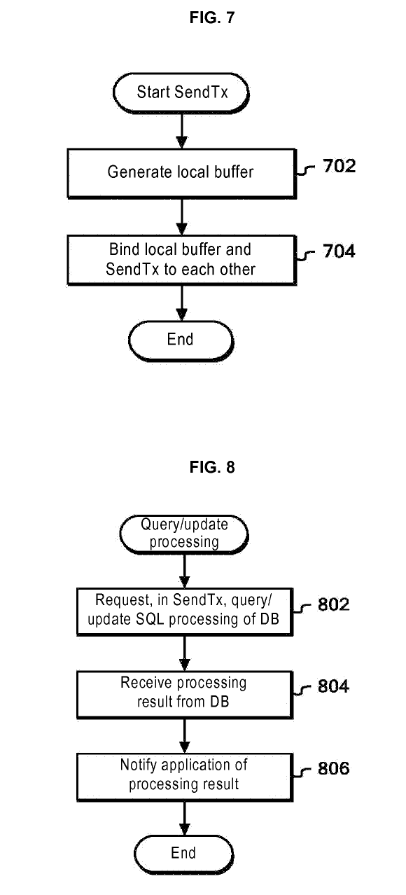

Individual processing with the middleware in application server 602 will be described with reference to FIGS. 7 to 15.

FIG. 7 is a diagram showing a flowchart of transmission transaction start processing in the middleware. In step 702, the middleware of server 602 generates local buffer 604, and then binds local buffer 604 and the transmission transaction to each other, in step 704. This is achieved by generating local buffer 604 as a thread local object.

FIG. 8 is a diagram showing a flowchart of query/update processing by means of the transmission transaction. In step 802, the middleware of server 602 requests query/update SQL processing of the database as the transmission transaction.

In step 804, the middleware receives the processing result from the database. In step 806, the middleware notifies the application of the processing result and ends query/update processing.

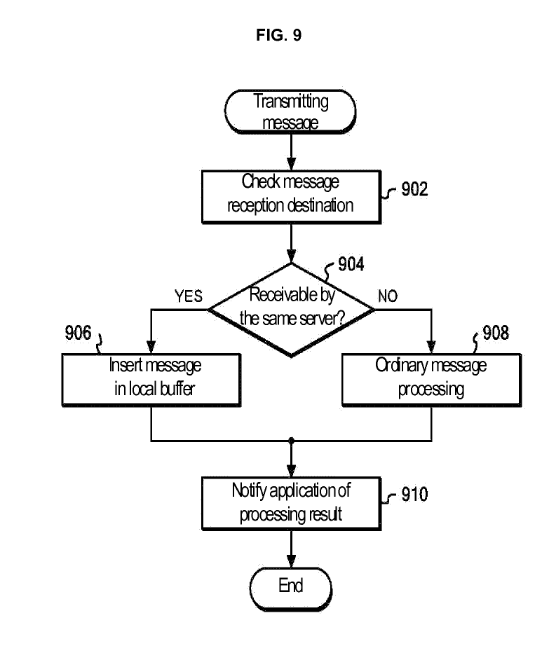

FIG. 9 is a diagram showing a flowchart of message transmission processing in the transmission transaction in the middleware. The middleware in server 602 checks the destination of transmission of a message in step 902.

In step 904, the middleware determines whether or not the message can be received in the same server. For example, in EJB3.0 of Java®, a message transmission destination and a reception destination are determined at the time of deployment of an application, thereby enabling identifying to which destination a message is to be transmitted and in which portion of a program is enabled.

If it is determined in step 904 that the message can be received in the same server, the middleware inserts the message in local buffer 604. If the message cannot be received in the same server, the middleware performs ordinary processing in step 908 without using local buffer 604.

After step 906 or step 908, the middleware notifies the application of the processing result in step 910 and ends message transmission processing.

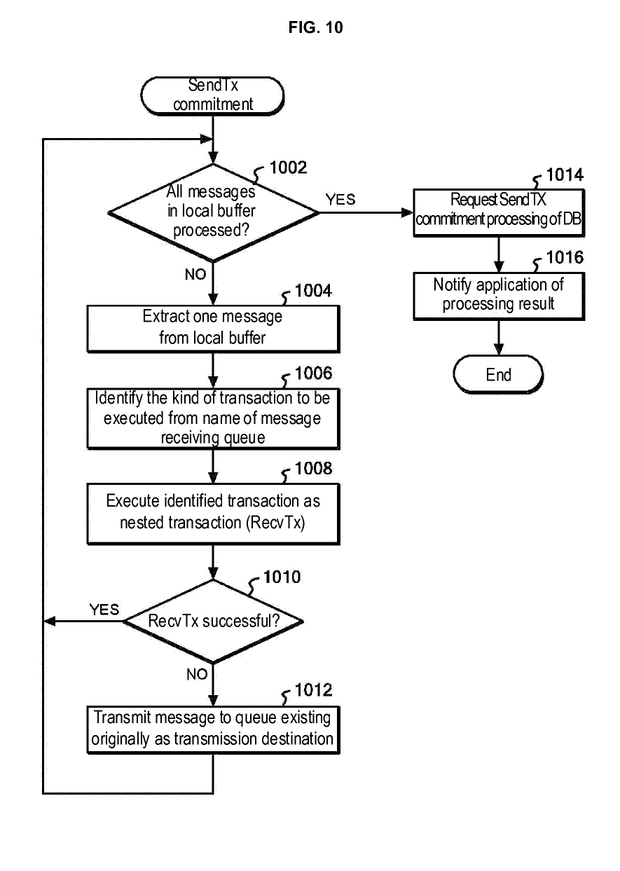

FIG. 10 is a diagram showing a flowchart of transmission transaction commitment processing in the middleware. In step 1002, the middleware in server 602 determines whether or not all messages in local buffer 604 have been processed. If all the messages have not been processed, the middleware extracts one message from local buffer 604 in step 1004.

In step 1006, the middleware identifies the kind of a transaction to be executed from a name of a queue that receives the message. The application prepares a special class for processing a message and determines at the time of deployment a name of a queue that receives the message. A queue as a destination of reception of the message is designated in the class. Thereby identification of the kind of a transaction to be executed from a name of a queue that receives a message is enabled in this way.

In step 1008, the middleware executes the identified transaction as a nested transaction (RecvTx). In step 1010, the middleware determines whether or not RecvTx has succeeded. If RecvTx has succeeded, the middleware returns the process to step 1002. If RecvTx has not succeeded, the middleware transmits the message to the queue to which it would have originally been transmitted, and returns the process to step 1002.

When the middleware determines in step 1002 that all the messages in local buffer 604 have been processed, it sends a request for commitment of the transmission transaction to database in step 1014, notifies the application of the processing result in step 1016 and ends transmission transaction commitment processing.

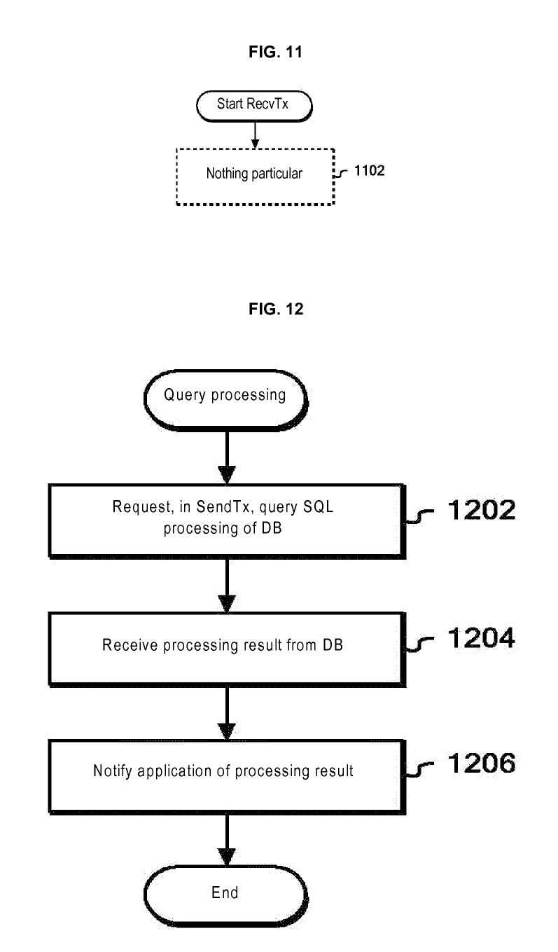

FIG. 11 is a diagram showing a flowchart of reception transaction start processing in the middleware. As indicated by reference numeral 1102 in FIG. 11, no processing is performed at the start of the reception transaction.

FIG. 12 is a diagram showing a flowchart of query processing in the reception transaction in the middleware. In step 1202, the middleware requests query SQL processing of the database as the transmission transaction.

The middleware receives the processing result from the database in step 1204, notifies the application of the processing result in step 1206, and ends query processing in the reception transaction.

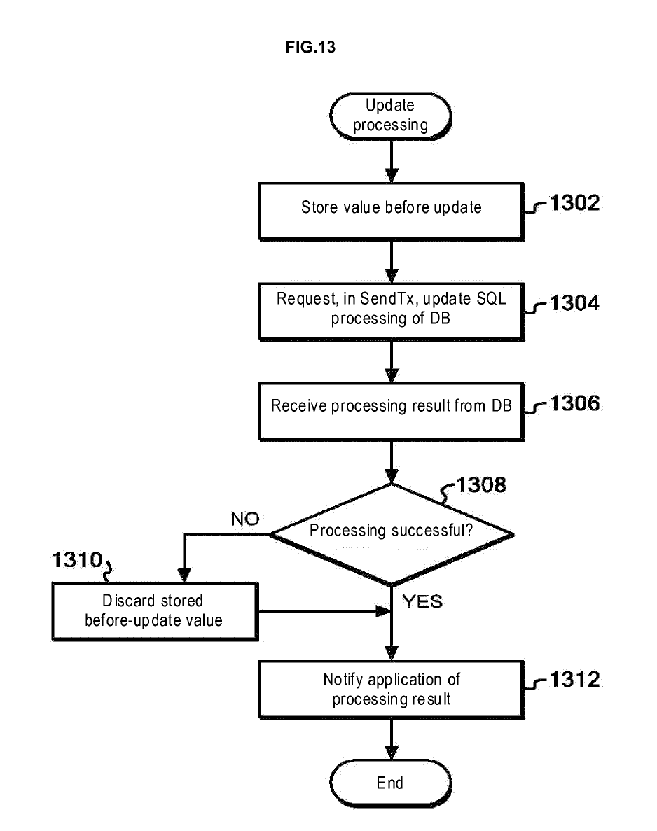

FIG. 13 is a diagram showing a flowchart of update processing in the reception transaction in the middleware. In step 1302, the middleware stores the value before update.

In step 1304, the middleware requests update SQL processing of the database as the transmission transaction.

The middleware receives the processing result from the database in step 1306, and determines whether or not the processing has succeeded, in step 1308.

If the processing has not succeeded, the middleware, in step 1310, discards the value before update, notifies the application of the processing result, in step 1312, and ends reception transaction update processing. If the processing has succeeded, the middleware immediately notifies the application of the processing result, in step 1312, and ends reception transaction update processing.

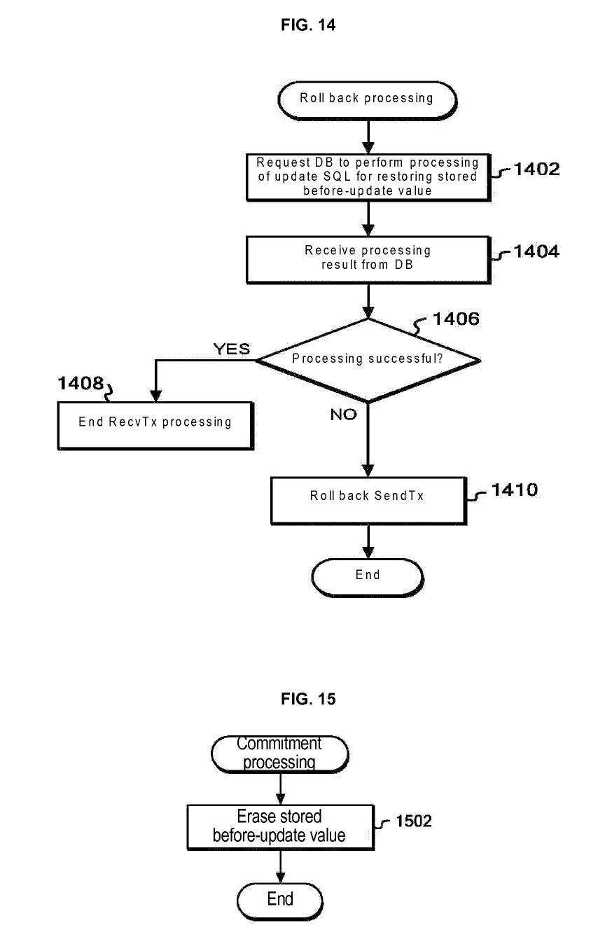

FIG. 14 is a diagram showing a flowchart of roll back processing in the reception transaction in the middleware. Referring to FIG. 14, the middleware requests the database in step 1402 to perform processing of update SQL for restoring the stored value before update.

The middleware receives in step 1404 the processing result from the database and determines in step 1406 whether or not the processing has succeeded. If the processing has succeeded, the middleware ends the processing in the reception transaction (RecvTx) in step 1408. If the processing has not succeeded, the middleware rolls back the transmission transaction and ends roll back processing in the reception transaction.

FIG. 15 is a diagram showing a flowchart of commitment processing in the reception transaction in the middleware. Referring to FIG. 15, the middleware deletes the stored value before update and ends commitment processing in the reception transaction.

This invention has been described with respect to an embodiment in Java® and WAS. However, it is to be understood that this invention is not limited to particular hardware and software and a particular platform, and that this invention can be applied to any processing for performing message-based transaction processing.

What is claimed is:

1. A method for processing in a system in which message transmission processing between applications and data processing on a database system are performed as one transmission transaction by means of processing with a computer, and in which message reception processing between the applications and data processing on the database system are performed as one reception transaction by means of processing with the computer, the method including processing the two transactions as one transaction in a case where the message transmission processing and the message reception processing between the applications are performed in one server system, the method comprising:
generating a local buffer at the time of starting the transmission transaction;
inserting a message in the local buffer at the time of transmission processing;
processing reception transaction on all messages in the local buffer; and
processing for commitment to a database;
wherein the processing steps are performed sequentially or simultaneously.

2. The method according to claim 1, further comprising:
storing a value before update in update processing on the database in the reception transaction processing;
rolling back data to the database to the value before update if the receiving transaction ends; and
transmitting the message to a destination designated by the transmission transaction.

3. The method according to claim 1, wherein generating the local buffer further includes:
checking a destination of reception of the message;
determining whether or not the message can be received by the same server; and
generating the local buffer if the message can be received by the same server.

4. The method according to claim 1, wherein the reception transaction processing on all the messages in the local buffer further includes identifying a transaction to be executed from a name of a queue that receives the message.

5. The method according to claim 1, wherein the server system is formed based on Java®, and the message is generated by JMS.

6. A computer program product for processing in a system in which message transmission processing between applications and data processing on a database system are performed as one transmission transaction by means of processing with a computer, and in which message reception processing between the applications and data processing on the database system are performed as one reception transaction by means of processing with the computer, processing performed by the program product including processing the two transactions as one transaction in a case where the message transmission processing and the message reception processing between the applications are performed in one server system, the program product comprising a computer readable storage medium having program code embodied therewith, the program code readable/executable by a device causing the server system to execute the steps of a method comprising:
generating a local buffer at the time of starting the transmission transaction;
inserting a message in the local buffer at the time of transmission processing; and
processing reception transaction on all messages in the local buffer; and
processing for commitment to a database;
wherein the processing steps are performed sequentially or simultaneously.

7. The computer program product according to claim 6, the program product causing the server system to further execute the steps of a method comprising:
storing a value before update in update processing on the database in the reception transaction processing;
rolling back data to the database to the value before update if the receiving transaction ends; and
transmitting the message to a destination designated by the transmission transaction.

8. The computer program product according to claim 6, wherein generating the local buffer further includes:
checking a destination of reception of the message;
determining whether or not the message can be received by the same server; and
generating the local buffer if the message can be received by the same server.

9. The computer program product according to claim 6, wherein the reception transaction processing on all the messages in the local buffer further includes identifying a transaction to be executed from a name of a queue that receives the message.

10. The computer program product according to claim 6, wherein the server system is formed based on Java®, and the message is generated by JMS.

11. A system in which message transmission processing between applications and data processing on a database system are performed as one transmission transaction by means of processing with a computer, in which message reception processing between the applications and data processing on the database system are performed as one reception transaction by means of processing with the computer, and in which the two transactions are processed as one transaction in a case where the message transmission processing and the message reception processing between the applications are performed as one server system, the system comprising:
a memory;
a processor communicatively coupled to the memory; and
a module communicatively coupled to the memory and the processor, wherein the module is configured to perform the steps of a method comprising:
generating a local buffer at the time of starting the transmission transaction;
inserting a message in the local buffer at the time of transmission processing; and
processing reception transaction on all messages in the local buffer; and
processing for commitment to a database;
wherein the processing steps are performed sequentially or simultaneously.

12. The system according to claim 11, wherein the module performs the steps of the method further comprising:
storing a value before update in update processing on the database in the reception transaction processing;
rolling back data to the database to the value before update if the receiving transaction ends; and
transmitting the message to a destination designated by the transmission transaction.

13. The system according to claim 11, wherein generating the local buffer further includes:
checking a destination of reception of the message;
determining whether or not the message can be received by the same server; and
generating the local buffer if the message can be received by the same server.

14. The system according to claim 11, wherein the reception transaction processing on all the messages in the local buffer further includes identifying a transaction to be executed from a name of a queue that receives the message.

15. The system according to claim 11, wherein the server system is formed based on Java®, and the message is generated by JMS.

16. A computer implemented method for processing transmission and reception transactions, the method comprising the steps of:
generating a local buffer at the time of starting the transmission transaction;
inserting a message in the local buffer at the time of transmission processing;
processing reception transaction on all messages in the local buffer; and
processing the transmission and reception transactions for commitment to a database;
wherein the processing steps are performed sequentially or simultaneously.
